(19) United States
(12) Patent Application Publication
(10) Pub. No.: US 2013/0268832 A1
(43) Pub. Date: Oct. 10, 2013

(54) METHOD AND SYSTEM FOR CREATING DIGITAL BOOKMARKS

(71) Applicant: Nagarjuna R. Vemireddy, Charlotte, NC (US)

(72) Inventor: Nagarjuna R. Vemireddy, Charlotte, NC (US)

(73) Assignee: INTERNATIONAL BUSINESS MACHINES CORPORATION, Armonk, NY (US)

(21) Appl. No.: 13/443,262

(22) Filed: Apr. 10, 2012

(51) Int. Cl. G06F 17/21

(52) U.S. Cl. 715/206

(57) ABSTRACT

A software application is disclosed for creating digital bookmarks corresponding to a portion of a document for presentation on a user's computer. Information is received indicating a selection of a portion of a document a user desires to bookmark. The section identifier(s) corresponding to the selected portion is determined and stored in a bookmark along with the URL of the document. The stored bookmark can subsequently be used to retrieve the selected portion from a network server. Information indicating a preferred output format is received and used to present the selected portion in the preferred output format in a compatible display application.

### FIELD OF THE INVENTION

The present invention relates generally to web browsers, and more particularly to the creation of digital bookmarks for accessing documents via a web browser.

### BACKGROUND

A markup language is used to define the content, layout and presentation style of an electronic document. The language uses pairs of markup tags delimit portions of the content and specify the layout and presentation style of content within each pair of tags. Most markup languages are human readable and the tags contain symbols to be distinguishable from the content. For example, “<” and “>” are symbols commonly used to denote markup tags. Any text that appears between a pair of these symbols is considered part of the markup language tag and not part of the content. Examples of document markup languages include Rich Text Format (RTF), Extensible Markup Language (XML), Extensible Hypertext Markup Language (XHTML) and Hypertext Markup Language (HTML). A typical feature found in markup languages is the ability to embed selectable links in a document, such as a web page, that will be rendered by a web browser and allow users to easily navigate to other web pages represented by the link.

A universal resource locator (URL) represents the network location of resources, such as HTML documents, audio files and video files. The resources may be cached on a user's own computer or stored on another computer accessible via the Internet. In particular, the resources may reside on a networked web server computer. A logical grouping of HTML documents may be combined to form a website. For example, a group of HTML documents all related to an electronics store can be organized in a hierarchical structure to allow users to navigate between relevant documents with ease. A high level page may list all categories of products, while links on this page allow the user to navigate to a specific product category, and links on that page will allow the user to browse a specific item for sale. The World Wide Web (WWW) is a collection of websites and associated hardware and software to interconnect them. Users select, retrieve and display content from websites by utilizing software called a web browser.

As the Internet has become more popular, the number of websites has grown exponentially. Memorizing the URL of an often visited website can be difficult and recording or storing the URL alone can be insufficient because the URL is not always suggestive of the content of a website. Bookmarks were developed to facilitate the web browsing process.

Bookmarks allow a user to associate the URL of any web page with a brief, easy to remember textual description of the web page, for example, the web page title. Each bookmark is also a hyperlink to the website. At the user's request, the browser associates a URL with a textual description and stores the data as a bookmark, which is typically stored in a bookmark folder located in the user's computer. Typically, bookmarks are selected by a user of a workstation by capturing the URL of a web page that is currently displayed. At the user's request, the browser displays these stored bookmarks, typically in a drop-down menu. Upon selecting a bookmark, the browser retrieves the web page or other resource found at the associated URL. This allows a user to quickly retrieve resources from previously visited websites whose URLs have been stored as bookmarks.

Popular web browsers that have a bookmark function include Firefox™ web browser (a trademark of Mozilla .org), Internet Explorer™ web browser (a trademark of Microsoft Corp.), Chrome™ web browser (a trademark of Google, Inc.), and Safari™ web browser (a trademark of Apple, Inc.).

As described above, when a web page is bookmarked and later selected, the entire web page is generally displayed by the web browser even though only a portion of the page may be of interest. This can make it difficult to find the portion of interest in the page, especially if the web page is long or verbose.

It was known to create a bookmark that references a specific location within a web page. U.S. Patent Application Publication US 2010/0223542 A1 to Thanh Vinh Vuong, et al., discloses a method for creating bookmarks by determining and storing positional data associated with a selection of a portion of a web page, such as pixels or a unit of measure such as centimeters and inches, along with an identifier of the web page, such as the URL. When the bookmark is selected, the full web page corresponding to the identifier is retrieved and positioned in the display window such that the selected portion is at least partially visible.

### SUMMARY

Embodiments of the present invention provide a system, method, and program product for creating a digital bookmark corresponding to a portion, selected by a user, of web page content which is displayed on a screen of a computer. The computer receives a user selection of the portion of the displayed web page content. The computer correlates the portion to one or more section identifiers in the markup language section that corresponds to the selected portion of the displayed web page content. The computer creates a digital bookmark that includes the section identifier and the document identifier.

In certain embodiments, responsive to the user selection of the portion of the web page, the computer displays on the screen a user-selectable option to create the digital bookmark, and responsive to user selection of the option to create the digital bookmark, the computer creates a digital bookmark that includes the section identifier and the document identifier.

In certain embodiments, the computer receives an indication that the digital bookmark has been selected by the user. The computer retrieves the document identified by the document identifier included in the digital bookmark. The computer identifies the section of markup language that corresponds to the section identifier included in the digital bookmark. The computer displays on the screen the web page content that corresponds to the identified section of markup language.

In certain embodiments, the computer identifies header tags that correspond to the identified section of markup language. The computer processes the identified header tags to format the section of web page content.

In certain embodiments, the computer visually distinguishes from the remainder of the web page content, the web page content corresponding to the identified section of markup language. In other embodiments, the computer displays on the screen only web page content that corresponds to the identified section of markup language.

In certain embodiments, the computer receives information indicating a preferred output format for the web page content corresponding to the section identifier specified in the digital bookmark. The computer uses file conversion software to convert the web page content corresponding to the section identifier specified in the digital bookmark into the preferred output format. The computer invokes a compatible application to display the web page content that corresponds to the section identifier specified in the digital bookmark.

### BRIEF DESCRIPTION OF THE SEVERAL VIEWS OF THE DRAWINGS

FIG. 1 illustrates a digital bookmarking system including a bookmark add-on program and a web browser, in accordance with an embodiment of the present invention.

FIG. 2 is a flowchart illustrating the function and operation of the bookmark add-on program of FIG. 1 in creating a bookmark, in accordance with a preferred embodiment of the invention.

FIG. 3 is a document representation displayed via the web browser of FIG. 1, in accordance with an embodiment of the present invention.

FIG. 4 is a flowchart describing the function and operation of the bookmark add-on program of FIG. 1 in retrieving a selected/bookmarked portion of a document referenced in a stored bookmark, in accordance with a preferred embodiment of the invention.

FIG. 5 is a document representation displayed via the web browser of FIG. 1, in accordance with an embodiment of the present invention.

FIG. 6 depicts a block diagram of hardware and software within a computing device and network server of FIG. 1.

### DETAILED DESCRIPTION

Embodiments of the present invention will now be described in detail with reference to the accompanying Figures.

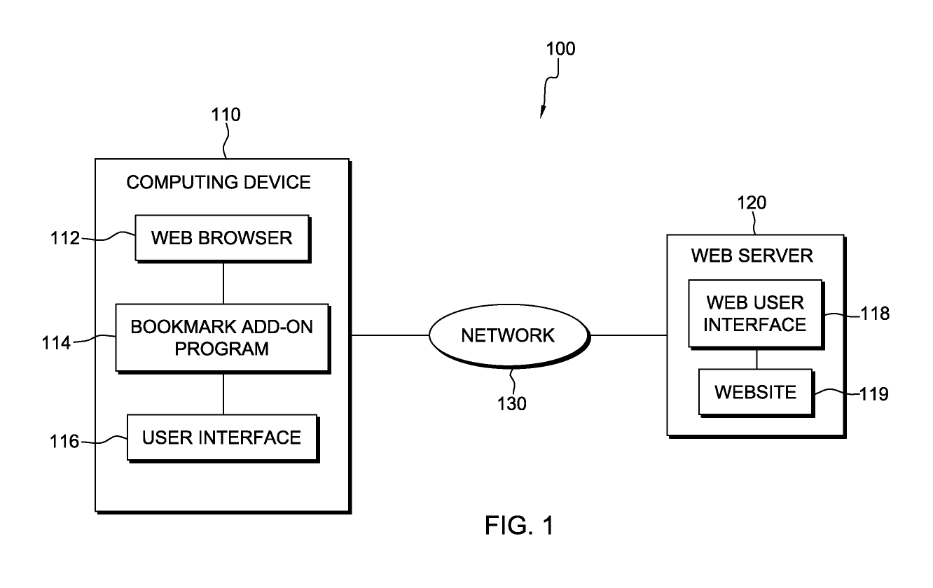

FIG. 1 illustrates a digital bookmarking system 100 for producing digital bookmarks in accordance with a preferred embodiment of the invention. Digital bookmarking system 100 includes computing device 110 and web server 120 interconnected by network 130.

In the preferred embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between computing device 110 and web server 120 in accordance with an embodiment of the invention.

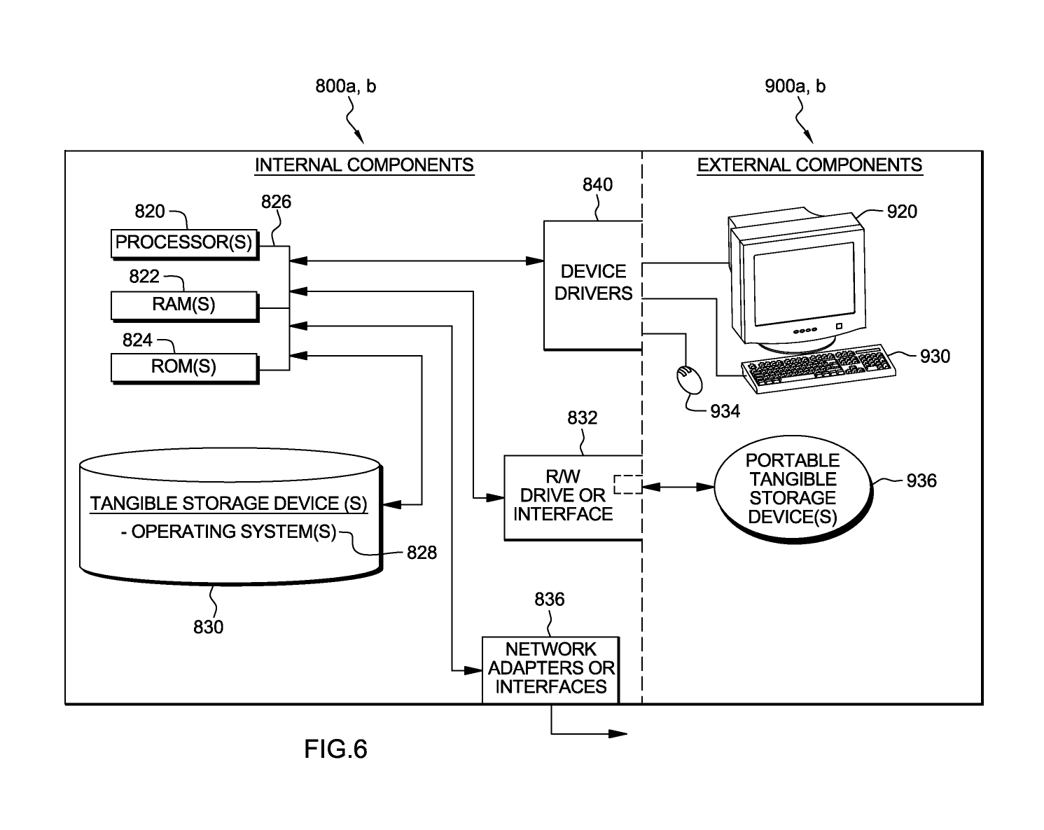

Web server 120 includes a collection of HTML documents representing web pages of website 119, and web user interface (WUI) 118 to process requests for and download the requested web pages. Although not shown, optionally, web server 120 can comprise a cluster of web servers executing the same software to collectively process the requests for the web pages as distributed by a front end server and a load balancer. Web server 120 may be a desktop computer, a notebook, a laptop computer, a tablet computer, a handheld device, a smart-phone, a thin client, or any other electronic device or computing system capable of receiving and sending data to and from computing device 110 via network 130. In a preferred embodiment, web server 120 is a computing device that is optimized for the support of websites which reside on web server 120, such as website 119, and for the support of network requests related to websites which reside on web server 120. Web server 120 is described in more detail with reference to FIG. 6.

Website 119 is a collection of documents, such as web pages. In a preferred embodiment, website 119 is a collection of documents in HTML form. Website 119 can also include other resources such as audio files and video files.

WUI 118 is a type of graphical user interface that receives input from, for example, a web browser, and provides output to the browser by retrieving documents, such as HTML web pages and other resources and information from a website. In a preferred embodiment, WUI 118 receives input from web browser 112, and provides to web browser 112 web pages and other information from website 119, which are transmitted via network 130 and displayed on display device 920 (see FIG. 6) of computing device 110 using web browser 112.

Computing device 110 includes web browser 112, bookmark add-on program 114 and user interface 116. Computing Device 110 may be a desktop computer, a notebook, a laptop computer, a tablet computer, a handheld device, a smart-phone, a thin client, or any other electronic device or computing system capable of receiving input from a user, executing computer program instructions, and communicating with another computing system via network 130. In general, computing device 110 is any programmable device that includes a network interface that allows for network connectivity, a display device, a tangible storage device and a user interface that allows for selection of text and other elements displayed on a display device. Computing device 110 will be described in more detail with reference to FIG. 6.

Web browser 112 is a program that enables users to view, watch, or listen to documents and other resources, such as audio and video files, retrieved from a network device. In a preferred embodiment, web browser 112 requests documents and other resources, identified by their URL, from web server 120 via network 130. Web browser 112 transmits requests to WUI 118 for documents and/or resources contained in website 119. WUI 118 responds to the requests by retrieving the documents and resources from website 119, and transmitting them back to web browser 112. In a preferred embodiment, documents and resources retrieved by web browser 112 are viewed by a user of computing device 110 on a display device, such as display device 920, via user interface 116. In general, web browser 112 can be any browser application capable of execution on a computing device, and capable of supporting bookmarking functionality.

User interface 116 includes components used to receive input from a user and transmit the input to an application. User interface 116 uses a combination of technologies and devices, such as device drivers, to provide a platform to enable users to interact with an application. In a preferred embodiment, user interface 116 receives input, such as input indicating selections within the display window of web browser 112 displayed on display device 920, from a physical input device, such as pointing device 934, via a device driver that corresponds to the input device, such as device driver 840. User interface 116 communicates these selections to web browser 112 and displays them on display device 920.

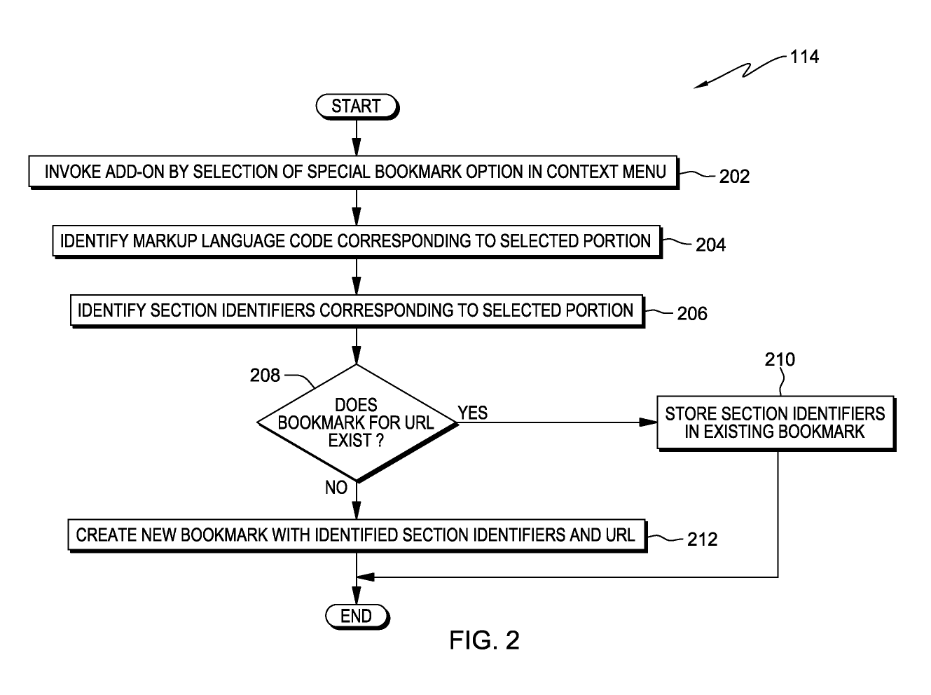

In a preferred embodiment, bookmark add-on program 114, the operation of which is explained in greater detail below with respect to FIGS. 2-5, operates in conjunction with web browser 112 to create and store bookmarks. Bookmarks created by bookmark add-on program 114 not only reference a document, but also a section of the document selected via user interface 116 while the document is displayed on display device 920 via web browser 112. While bookmark add-on program 114 is shown as a separate component, in other embodiments, bookmark add-on program 114 can be fully integrated with web browser 112. According to the present invention, a bookmark created by bookmark add-on program 114 represents a section of web page content, and upon selection of the bookmark, web browser 112 displays this section without the remainder of the web page.

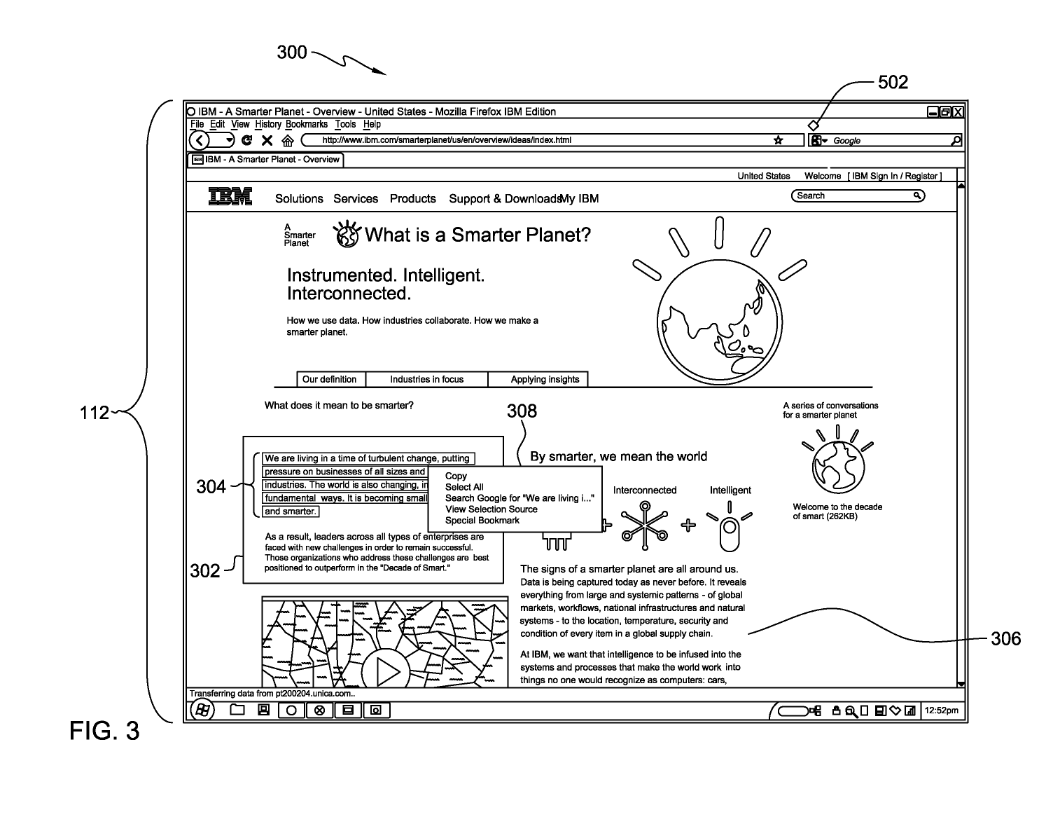

FIG. 2 is a flowchart illustrating the function and operation of bookmark add-on program 114 in creating a bookmark, in accordance with a preferred embodiment of the invention. In a preferred embodiment, bookmark add-on program 114 is invoked by the selection of a “Special Bookmark” option from context menu 308 (see FIG. 3) via user interface 116 (step 202). For example, bookmark add-on program 114 can be invoked by user selection of the “Special Bookmark” option which becomes available in context menu 308 after the user has selected a portion of a document that is part of website 119 which has been retrieved by web browser 112 via WUI 118 over network 130. Selection of the desired portion of the displayed document, or of the bookmark add-on context menu item, is accomplished via an input to user interface 116 from an input device such as, a mouse, a keyboard, a touchscreen, voice recognition software, gesture recognition software or a combination of one or more input devices.

In another embodiment, web browser 112 invokes bookmark add-on program 114 in response to a user selection of a portion of a document, displayed on display device 920, that is part of website 119 that has been retrieved by web browser 112 via WUI 118 over network 130. For example, when a user of computing device 110 selects a portion of a document, web browser 112 initiates bookmark add-on program 114, even in the absence of direct invocation by the user of bookmark add-on program 114.

Bookmark add-on program 114 then identifies the portion of markup language code corresponding to the selected portion of the document displayed by web browser 112 (step 204). This can be accomplished, for example, by utilizing known functionality embedded in many common web browsers, such as the popular web browsers noted above, or by incorporating this functionality into bookmark add-on program 114. For example, the Firefox web browser will display markup language code corresponding to a selected portion of a document with the “View Selection Source” context menu item, available after a portion of a displayed web page has been selected. An example of a process used by web browsers to determine the markup language corresponding to a selected portion of a displayed document image is described in U.S. Pat. No. 6,021,416 to Dauerer, et al., which is hereby incorporated by reference as part of the present disclosure. The Dauerer patent performs a sequence of checks (list check, table check, text check and graphics check) to determine the type of content present in the selected portion of web page content. For each type of content determined to be present, a matching test is performed to determine whether a string within the selected portion matches a string (or a portion of a string) within the primary HTML source file. These steps use known string matching techniques for determining: (1) whether a query string matches a target string stored in a stored file; and (2) whether a query string matches a portion of a target string stored in a file.

Bookmark add-on program 114 then identifies a section identifier(s) that corresponds with the selected portion of the document (step 206). Section identifiers are tags used in markup languages to uniquely identify sections of the markup language. Examples of section identifiers used in HTML are: DIV ID tags (specifies a unique ID for a division or section), span tags (used to group logically related text) and section tags (used to define a section of a document). In a preferred embodiment, bookmark add-on program 114 identifies a specific section identifier(s). For example, if bookmark add-on program 114 is programmed to identify section tags, it will search through the markup language and identify the section tag(s) corresponding to the selected portion of the document. In a preferred embodiment, bookmark add-on program 114 is programmed to identify DIV ID tags. In general, section identifiers correspond to specific sections within a document. If a user selects a portion of a section, the identified section identifier(s) will correspond to the entire section, not just the selected portion. In other words, if a bookmark is created by bookmark add-on program 114 for a portion of a section of a document, the bookmark will reference to the entire section, not just the portion. Similarly, if a user selects portions of three separate sections of a document, the bookmark created by bookmark add-on program 114 will reference all three sections in their entirety. If a user selects a portion that spans more than one section, the bookmark will reference all sections that contain the selected content.

In a preferred embodiment, bookmark add-on program 114 then performs a check within its bookmark records for existing bookmarks with the same URL as the displayed document (decision 208). If there is an existing bookmark with the same URL, bookmark add-on program 114 adds the newly identified section identifier(s) to the existing bookmark (step 210). In other embodiments, when there is an existing bookmark or multiple existing bookmarks with the same URL, an option is presented to the user to either add the newly identified section identifier(s) to an existing bookmark or to create a new bookmark containing the newly identified section identifier(s). If there is no existing bookmark with the same URL, the newly identified section identifier(s) are stored in a new bookmark along with the URL of the document (step 212). Bookmarks are stored in a memory device such as tangible storage device 830 or portable tangible storage device 936, which are discussed in greater detail below.

FIG. 3 depicts document representation 300 which shows a markup language document/web page from website 119 that contains document content 306 and is displayed by web browser 112 on display device 920 after it has been retrieved by web browser 112. As shown in the figure, selected portion 304 represents a portion of the document as displayed on display device 920 that has been selected via user interface 116. Also shown is selection of the “Special Bookmark” option in context menu 308, by which bookmark add-on program 114 is invoked (see step 202, FIG. 2). As described above, once invoked, bookmark add-on program 114 stores the identified section identifier(s) that corresponds with selected portion 304 and the URL of the document in a new or existing bookmark (see steps 208-212). In this example, the identified section identifier(s) corresponds to section of content 302 which contains selected portion 304.

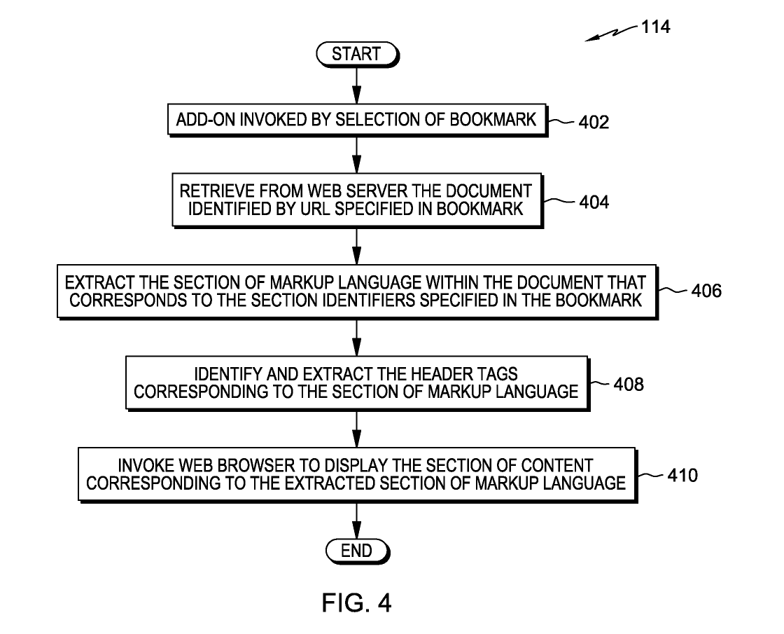

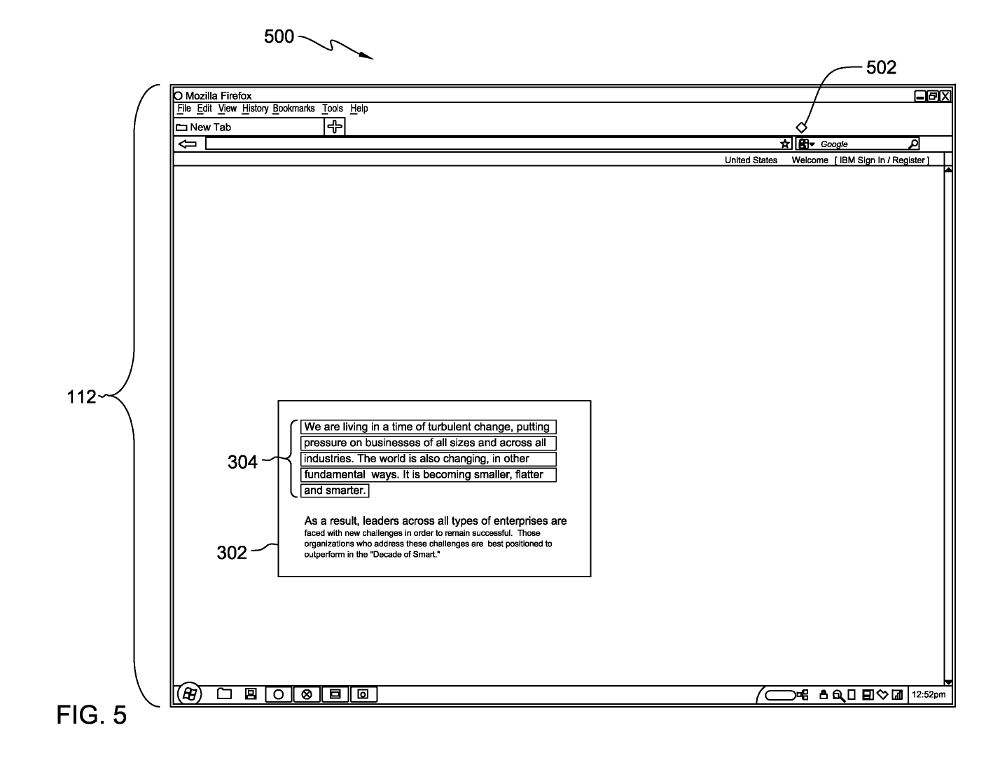

FIG. 4 is a flowchart describing the function and operation of bookmark add-on program 114 in retrieving a selected/bookmarked portion of a document referenced in a stored bookmark, in accordance with a preferred embodiment of the invention. Bookmark add-on program 114 is invoked when a stored bookmark is selected by the user of computing device 110 (step 402). In a preferred embodiment, stored bookmarks are listed in a drop down menu which is accessed via a “Special Bookmark” icon 502 (see FIG. 5) located on the toolbar of web browser 112. In other embodiments, the desired bookmark can be selected, for example, by a mouse from a context menu that can be displayed while the web browser 112 is the active window on display device 920.

Bookmark add-on program 114 then requests the website 119 document identified by the URL specified in the stored bookmark from web server 120 via network 130 (step 404). In another embodiment, bookmark add-on program 114 instructs web browser 112 to retrieve the document identified by the URL specified in the stored bookmark from web server 120 via network 130.

Bookmark add-on program 114 then extracts the section(s) of markup language contained within the document that corresponds to the section identifier(s) and web page specified in the stored bookmark (step 406). Because website content and structure typically change over time, it is possible that the content of the document section referenced in the bookmark has changed between the time the bookmark was created and stored, and when the section is retrieved as a result of selecting the bookmark. If the content of the document section has been changed or updated subsequent to the creation of the bookmark, the bookmark will extract the current version of the section. If the document section has been deleted by the website administrator subsequent to the creation of the bookmark, bookmark add-on program 114 will provide notification to the user, such as a pop-up message, via user interface 116, indicating the section has been removed. Bookmark add-on program 114 will then retrieve the current version of the corresponding document in its entirety. If the entire document has been deleted by the website administrator subsequent to the creation of the bookmark, bookmark add-on program 114 will provide notification to the user via user interface 116 indicating the document has been removed.

In an alternate embodiment, bookmark add-on program 114 stores the section of content corresponding to the identified section identifier(s) in the bookmark with the identified section identifier(s) and the document identifier. As described above, it is possible the section of content corresponding to the section identifier(s) referenced in the bookmark has changed between the time the bookmark was created and stored, and when the document is retrieved as a result of selecting the bookmark. For cases where the section of content has been changed or updated subsequent to the creation of the bookmark and bookmark add-on program 114 is unable to locate the updated section of content within the retrieved document using the identified section identifier(s) (because the changed document does not include the original section identifier(s)), bookmark add-on program 114 uses word matching software to compare the section of content stored in the bookmark to the content of the retrieved document. The word matching software compares the stored section from the original document to the entire, current document looking for words and their sequence in the stored section and comparing them to words and their sequence in the entire, current document to find a matching section in the current document. The word matching software has a set threshold matching level (of a percentage of words in a proper sequence) that must be reached in order for the updated section of content to be deemed a match. If the threshold matching level is reached, bookmark add-on program 114 will extract the updated section of content and invoke a compatible application to display the updated section of content. If there is no matching section of content found, bookmark add-on program 114 will invoke a compatible application to display the original section of content stored in the bookmark.

In a preferred embodiment, bookmark add-on program 114 then identifies and extracts the specific header tags that correspond to the section(s) of the markup language corresponding to the section identifier(s) referenced in the stored bookmark (step 408). Header tags are used in markup languages to define the organizational structure and format of a document, such as font size, color and placement. In other words, the header tags help to preserve the format and structure of the section(s) of the document corresponding to the identified section identifier(s), which are not specified in the section identifier(s) themselves, if the section(s) are subsequently extracted from the document and displayed in an application compatible with markup language, such as a web browser.

In a preferred embodiment, bookmark add-on program 114 then invokes web browser 112 to display the section(s) of content that corresponds to the section identifier(s) specified in the stored bookmark (step 410).

In another embodiment, bookmark add-on program 114 highlights or draws a box around the section(s) of content that corresponds to the section identifier(s) specified in the stored bookmark and darkens/de-emphasizes the rest of the document. The highlighted document is displayed to the user in a web browser 112 window on display device 920. This embodiment allows a user to quickly and easily identify the relevant section(s) while also retaining the format and structure of the document

In other embodiments, bookmark add-on program 114 receives information regarding the preferred output format of the section(s) of content that corresponds to the section identifier(s) referenced in the stored bookmark via the user interface 116. For example, the preferred output format is received via user input made in a format menu which is accessed by “Special Bookmark” icon 502 located on the toolbar of web browser 112. Examples of output formats include: pdf (displayed by a pdf application), text (displayed by a word processor), and doc (displayed by a word processor). In this embodiment, bookmark add-on program 114 contains file conversion software which is used to convert the corresponding section(s) of content into non-proprietary or licensed preferred output formats. Bookmark add-on program 114 extracts the section(s) of content and uses file conversion software to convert the extracted section(s) of content into the specified preferred output format, and, for example, stores the converted section in a temporary file on storage device 830. In this embodiment, the header tags corresponding to the section(s) of markup language that correspond to the section(s) of content are not identified or extracted. Bookmark add-on program 114 then invokes a display application compatible with the preferred output format to display the extracted section(s) of content. For example, if the preferred output format is text, bookmark add-on program 114 would convert the corresponding section(s) of content into text format and invoke a display application compatible with text such as Microsoft Word™ (a trademark of Microsoft) or Notepad™ (a trademark of Microsoft) to display the section(s) of content.

FIG. 5 depicts document representation 500, which illustrates the content retrieved by bookmark add-on program 114 when the bookmark created by the process in FIG. 2 is selected by the user of computing device 110, as illustrated in FIG. 3, and displayed, for example, by web browser 112. Specifically, FIG. 5 shows, for example, section of content 302, which corresponds to the identified section identifier(s) stored in the bookmark. Within section of content 302 is selected portion 304, which is the portion selected by the user of computing device 110, as illustrated in FIG. 3. Because the section identifier(s) stored in the bookmark corresponds to section of content 302, not just selected portion 304 within section of content 302, document representation 500 shows all of section of content 302 displayed by web browser 112, rather than just selected portion 304.

Computing device 110 or web server 120 include respective sets of internal components 800 a, b and external components 900 a, b illustrated in FIG. 6. Each of the sets of internal components 800 a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and programs web browser 112, bookmark add-on program 114 and user interface 116 in computing device 110; and programs WUI 118 and website 119 in web server 120 are stored on one or more of the respective computer-readable tangible storage devices 830 for execution by one or more of the respective processors 820 via one or more of the respective RAMs 822 (which typically include cache memory). In the embodiment illustrated in FIG. 6, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b also includes a R/W drive or interface 832 to read from and write to one or more portable computer-readable tangible storage devices 936 such as a CD-ROM, DVD, memory stick, magnetic tape, magnetic disk, optical disk or semiconductor storage device. The programs web browser 112, bookmark add-on program 114 and user interface 116 in computing device 110; and programs WUI and website 119 in network server 140 can be stored on one or more of the respective portable computer-readable tangible storage devices 936, read via the respective R/W drive or interface 832 and loaded into the respective hard drive 830.

Each set of internal components 800 a, b also includes network adapters or interfaces 836 such as a TCP/IP adapter cards, wireless wi-fi interface cards, or 3G or 4G wireless interface cards or other wired or wireless communication links. The programs web browser 112, bookmark add-on program 114 and user interface 116 in computing device 110; and programs WUI 118 and website 119 in network server 140 can be downloaded to respective computers 110 and 120 from an external computer via a network (for example, the Internet, a local area network or other, wide area network) and respective network adapters or interfaces 836. From the network adapters or interfaces 836, the programs web browser 112, bookmark add-on program 114 and user interface 116 in computing device 110; and programs WUI 118 and website 119 in network server 140 are loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The aforementioned programs can be written in any combination of one or more programming languages, including low-level, high-level, object-oriented or non object-oriented languages, such as Java, Smalltalk, C, and C++. Alternatively, the functions of the aforementioned programs can be implemented in whole or in part by computer circuits and other hardware (not shown).

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. A method for creating a digital bookmark corresponding to a portion, selected by a user, of web page content which is displayed on a screen of a computer, the displayed web page content corresponding to a markup language document, the markup language document divided into sections identified by respective section identifiers, the document having an associated document identifier, the method comprising the steps of:
the computer receiving a user selection of the portion of the displayed web page content;
the computer correlating the portion to one or more section identifiers in the markup language section that correspond to the selected portion of displayed web page content; and
the computer creating a digital bookmark that includes the section identifier and the document identifier.

2. The method of claim 1, further comprising the step of:
responsive to the user selection of the portion of the web page, the computer displaying on the screen a user-selectable option to create the digital bookmark, and
wherein the creating step further comprises:
the computer, responsive to user selection of the option to create the digital bookmark, creating a digital bookmark that includes the section identifier and the document identifier.

3. The method of claim 1, further comprising the steps of:
the computer storing the selected portion of web page content corresponding to the section identifier, in the digital bookmark with the section identifier and document identifier; and
responsive to the subsequent user selection of the bookmark, the computer retrieving the document identified by the document identifier included in the digital bookmark, the retrieved document including an updated version of the stored selected portion but not including the section identifier, the computer identifying the updated version in the retrieved document by comparing words in the stored selected portion to words in the retrieved document, and the computer displaying the updated version.

4. The method of claim 1, further comprising the steps of:
the computer receiving an indication that the digital bookmark has been selected by the user;
the computer retrieving the document identified by the document identifier included in the digital bookmark;
the computer identifying the section of markup language that corresponds to the section identifier included in the digital bookmark; and
the computer displaying on the screen the web page content that corresponds to the identified section of markup language.

5. The method of claim 4, further comprising the steps of:
the computer identifying header tags that correspond to the identified section of markup language; and
the computer processing the identified header tags to format the section of web page content.

6. The method of claim 4, wherein, the step of the computer displaying further comprises the computer visually distinguishing from the remainder of the web page content, the web page content corresponding to the identified section of markup language.

7. The method of claim 4, wherein, the step of the computer displaying further comprises the computer displaying on the screen only web page content that corresponds to the identified section of markup language.

8. The method of claim 4, further comprising the steps of:
the computer receiving information indicating a preferred output format for the web page content corresponding to the section identifier specified in the digital bookmark;
the computer using file conversion software to convert the web page content corresponding to the section identifier specified in the digital bookmark into the preferred output format; and
the computer invoking a compatible application to display the web page content that corresponds to the section identifier specified in the digital bookmark.

9. A computer program product for creating a digital bookmark corresponding to a portion, selected by a user, of web page content which is displayed on a screen of a computer, the displayed web page content corresponding to a markup language document, the markup language document divided into sections identified by respective section identifiers, the document having an associated document identifier, the program instructions comprising:
one or more computer-readable storage devices and program instructions stored on at least one of the one or more tangible storage devices, the program instructions comprising:
program instructions to receive a user selection of the portion of the displayed web page content;
program instructions to correlate the portion to one or more section identifiers in the markup language section that correspond to the selected portion of displayed web page content; and
program instructions to create a digital bookmark that includes the section identifier and the document identifier.

10. The computer program product of claim 9, the program instructions further comprising:
responsive to the user selection of the portion of the web page, program instructions to display on the screen a user-selectable option to create the digital bookmark, and
wherein the program instructions to create the digital bookmark further comprises:
program instructions, responsive to user selection of the option to create the digital bookmark, to create a digital bookmark that includes the section identifier and the document identifier.

11. The computer program product of claim 9, the program instructions further comprising:
program instructions to store the selected portion of web page content corresponding to the section identifier, in the digital bookmark with the section identifier and document identifier; and
program instructions to, responsive to the subsequent user selection of the bookmark, retrieve the document identified by the document identifier included in the digital bookmark, the retrieved document including an updated version of the stored selected portion but not including the section identifier, identify the updated version in the retrieved document by comparing words in the stored selected portion to words in the retrieved document, and display the updated version.

12. The computer program product of claim 9, the program instructions further comprising:
program instructions to receive an indication that the digital bookmark has been selected by the user;
program instructions to retrieve the document identified by the document identifier included in the digital bookmark;
program instructions to identify the section of markup language that corresponds to the section identifier included in the digital bookmark; and
program instructions to display on the screen the web page content that corresponds to the identified section of markup language.

13. The computer program product of claim 12, the program instructions further comprising:
program instructions to identify header tags that correspond to the identified section of markup language; and
program instructions to process the identified header tags to format the section of web page content.

14. The computer program product of claim 12, wherein, the program instructions to display further comprises program instructions to visually distinguish from the remainder of the web page content, the web page content corresponding to the identified section of markup language.

15. The computer program product of claim 12, wherein, the program instructions to display further comprises program instructions to display on the screen only web page content that corresponds to the identified section of markup language.

16. The computer program product of claim 12, the program instructions further comprising:
program instructions to receive information indicating a preferred output format for the web page content corresponding to the section identifier specified in the digital bookmark;
program instructions to use file conversion software to convert the web page content corresponding to the section identifier specified in the digital bookmark into the preferred output format; and
program instructions to invoke a compatible application to display the web page content that corresponds to the section identifier specified in the digital bookmark.

17. A computer system for creating a digital bookmark corresponding to a portion, selected by a user, of web page content which is displayed on a screen of a computer, the displayed web page content corresponding to a markup language document, the markup language document divided into sections identified by respective section identifiers, the document having an associated document identifier, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive a user selection of the portion of the displayed web page content;
program instructions to correlate the portion to one or more section identifiers in the markup language section that correspond to the selected portion of displayed web page content; and
program instructions to create a digital bookmark that includes the section identifier and the document identifier.

18. A computer system in accordance with claim 17, the program instructions further comprising:
responsive to the user selection of the portion of the web page, program instructions to display on the screen a user-selectable option to create the digital bookmark, and
wherein the program instructions to create the digital bookmark further comprises:
program instructions, responsive to user selection of the option to create the digital bookmark, to create a digital bookmark that includes the section identifier and the document identifier.

19. A computer system in accordance with claim 17, the program instructions further comprising:
program instructions to store the selected portion of web page content corresponding to the section identifier, in the digital bookmark with the section identifier and document identifier; and
program instructions to, responsive to the subsequent user selection of the bookmark, retrieve the document identified by the document identifier included in the digital bookmark, the retrieved document including an updated version of the stored selected portion but not including the section identifier, identify the updated version in the retrieved document by comparing words in the stored selected portion to words in the retrieved document, and display the updated version.

20. A computer system in accordance with claim 17, the program instructions further comprising:
program instructions to receive an indication that the digital bookmark has been selected by the user;
program instructions to retrieve the document identified by the document identifier included in the digital bookmark; and
program instructions to identify the section of markup language that corresponds to the section identifier included in the digital bookmark;
program instructions to display on the screen the web page content that corresponds to the identified section of markup language.

21. A computer system in accordance with claim 20, the program instructions further comprising:
program instructions to identify header tags that correspond to the identified section of markup language; and
program instructions to process the identified header tags to format the section of web page content.

22. A computer system in accordance with claim 20, wherein, the program instructions to display further comprises program instructions to visually distinguish from the remainder of the web page content, the web page content corresponding to the identified section of markup language.

23. A computer system in accordance with claim 20, wherein, the program instructions to display further comprises program instructions to display on the screen only web page content that corresponds to the identified section of markup language.

24. A computer system in accordance with claim 20, the program instructions further comprising:
program instructions to receive information indicating a preferred output format for the web page content corresponding to the section identifier specified in the digital bookmark;
program instructions to use file conversion software to convert the web page content corresponding to the section identifier specified in the digital bookmark into the preferred output format; and
program instructions to invoke a compatible application to display the web page content that corresponds to the section identifier specified in the digital bookmark.
